(19) United States
(12) Patent Application Publication
(10) Pub. No.: US 2019/0200571 A1
(43) Pub. Date: Jul. 4, 2019

(54) BELOW GROUND FEEDER

(71) Applicant: Nicholas James Renninger, Newville, PA (US)

(72) Inventor: Nicholas James Renninger, Newville, PA (US)

(21) Appl. No.: 15/861,797

(22) Filed: Jan. 4, 2018

(51) Int. Cl. A01K 5/01; A01K 5/02; A01K 39/014

(52) U.S. Cl. CPC A01K 5/01; A01K 39/014; A01K 5/025; A01K 5/0275

(57) ABSTRACT

A below ground feeder for baiting grazing animals includes a can that has a height of at least 2.0 feet and a diameter of at least 1.5 feet. The can is positioned in a hole in the ground thereby facilitating the can to be concealed from hunters. Additionally, the can contains a granular feed such that the granular feed may be consumed by a grazing animal. A lifting unit is movably positioned in the can and the lifting unit is biased to elevate the granular material in the can. Thus, the grazing animal may continuously access the granular feed. A lid is hingedly coupled to the can and lid selectively closes the can to inhibit animals from accessing the granular feed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to feeder devices and more particularly pertains to a new feeder device for baiting grazing animals.

### BRIEF SUMMARY OF THE INVENTION

An embodiment of the disclosure meets the needs presented above by generally comprising a can that has a height of at least 2.0 feet and a diameter of at least 1.5 feet. The can is positioned in a hole in the ground thereby facilitating the can to be concealed from hunters. Additionally, the can contains a granular feed such that the granular feed may be consumed by a grazing animal. A lifting unit is movably positioned in the can and the lifting unit is biased to elevate the granular material in the can. Thus, the grazing animal may continuously access the granular feed. A lid is hingedly coupled to the can and lid selectively closes the can to inhibit animals from accessing the granular feed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a below ground feeder according to an embodiment of the disclosure.

FIG. 2 is a perspective phantom view of an embodiment of the disclosure.

FIG. 3 is a bottom phantom view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

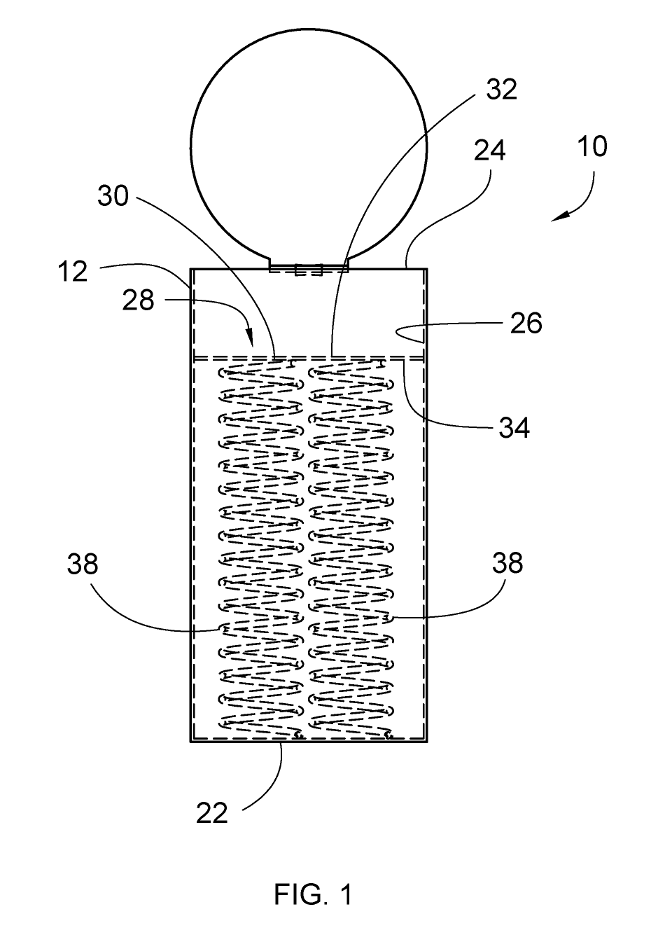

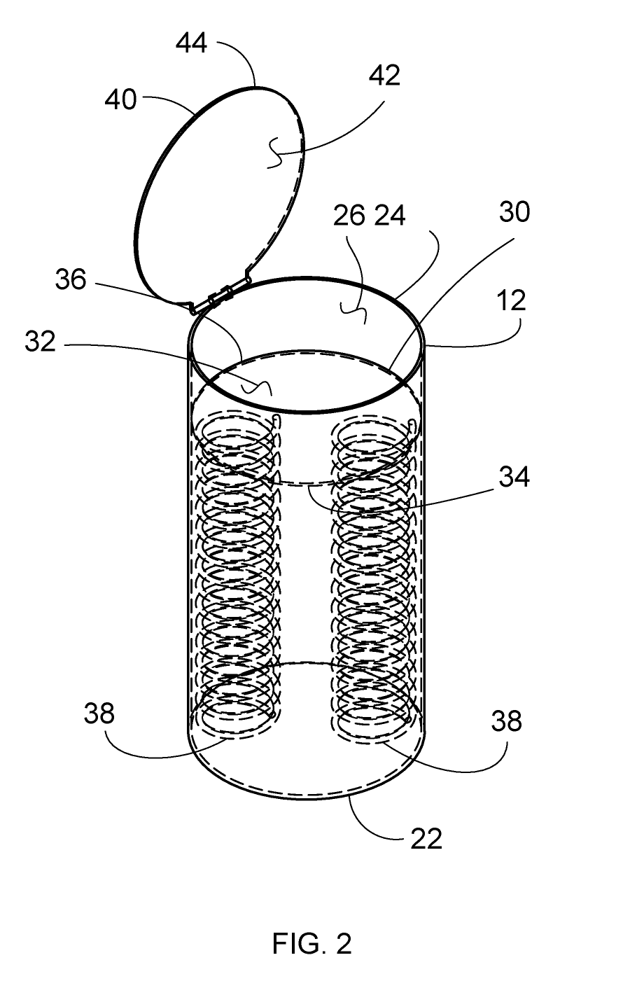

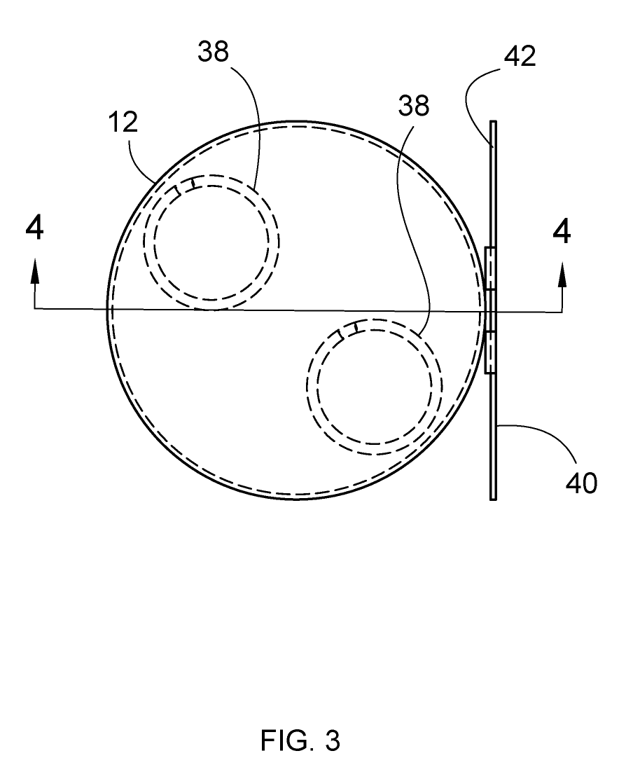

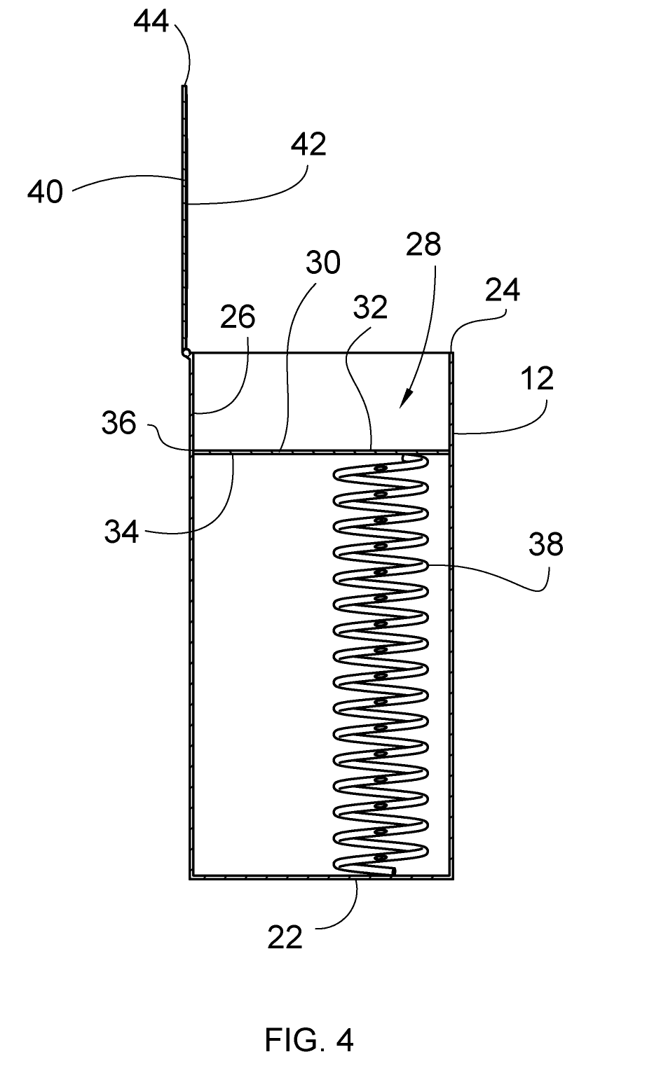

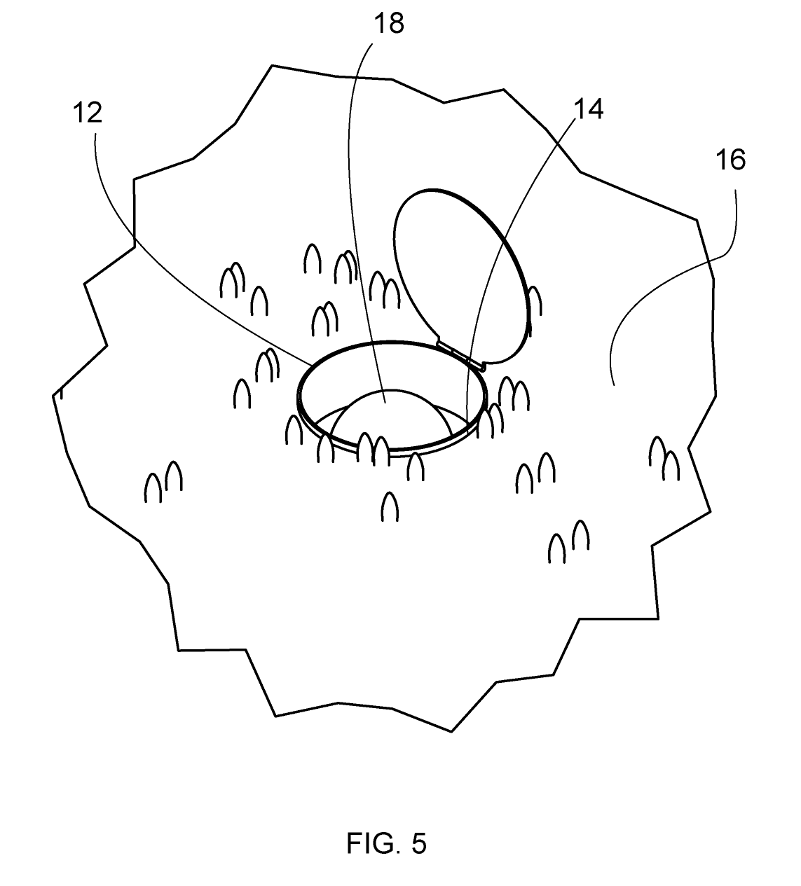

With reference now to the drawings, and in particular to FIGS. 1 through 5 thereof, a new feeder device embodying the principles and concepts of an embodiment of the disclosure and generally designated by the reference numeral 10 will be described.

As best illustrated in FIGS. 1 through 5, the below ground feeder 10 generally comprises a can 12 that may be positioned in a hole 14 in the ground 16. In this way the can 12 is concealed from hunters. The can 12 contains a granular feed 18, such as corn or the like, such that the granular feed 18 may be consumed by a grazing animal such as a deer or the like. Moreover, the granular feed 18 attracts the grazing animal to the can 12 for hunting purposes. The can 12 has a bottom end 22, a top end 24 and an inner surface 26 extending therebetween. The top end 24 is open and the bottom end 22 abuts a bottom of the hole 14. The top end 24 is aligned with the ground 16 thereby facilitating the grazing animal to access the granular feed 18.

A lifting unit 28 is provided and the lifting unit 28 is movably positioned in the can 12. The lifting unit 28 is biased to travel toward the top end 24 such that the lifting unit 28 positions the granular feed 18 adjacent to the top end 24. In this way the lifting unit 28 facilitates the grazing animal to continuously access the granular feed 18. The lifting unit 28 comprises a disk 30 that has a top surface 32, a bottom surface 34 and a perimeter edge 36 extending therebetween. The perimeter edge 36 abuts the inside surface of the can 12 to inhibit the granular feed 18 from passing between the disk 30 and the can 12 and the granular feed 18 is positioned on the top surface 32.

A biasing member 38 is positioned between the bottom surface 34 of the disk 30 and the bottom end 22 of the can 12. The biasing member 38 biases the disk 30 toward the top end 24 of the can 12. The biasing member 38 has a lifting force sufficient to lift the disk 30 as the granular feed 18 is consumed from the can 12 without forcing the granular feed 18 upwardly out of the can 12. Moreover, the biasing member 38 may be a spring or the like.

A lid 40 is hingedly coupled to the can 12 such that the lid 40 selectively closes the can 12. In this way the lid 40 inhibits animals, such as bears, raccoons and other scavengers, from accessing the granular feed 18. The lid 40 has a first surface 42 and an outer edge 44 and the outer edge 44 is hingedly coupled to the top end 24 of the can 12. The first surface 42 abuts the top end 24 of the can 12 when the lid 40 is closed.

In use, a hole 14 is dug in the ground 16 that has a sufficient diameter and depth to accommodate the can 12. Additionally, the hole 14 is dug to a depth that allows the top end 24 of the can 12 to be aligned with the ground 16 when the can 12 is positioned in the hole 14. In this way the can 12 is concealed from individuals other than a user of the can 12. The granular feed 18 is poured into the can 12 thereby facilitating the granular feed 18 to be consumed by the grazing animal. The lid 40 is opened when the user is hunting near the can 12 thereby facilitating the user to hunt the grazing animal. In this way the granular feed 18 attracts the grazing animal to move near the user. The lid 40 is closed when the user is not hunting thereby inhibiting scavenging animals, such as bears and raccoons, from accessing and consuming the granular feed 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A below ground feeder assembly being configured to dispense feed for a grazing animal, said assembly comprising:
a can having a height of at least 2.0 feet and a diameter of at least 1.5 feet, said can being configured to be positioned in a hole in the ground thereby facilitating said can to be concealed from hunters, said can containing a granular feed wherein said granular feed is configured to be consumed by a grazing animal;
a lifting unit being movably positioned in said can, said lifting unit being biased to elevate the granular feed wherein said lifting unit is configured facilitate the grazing animal to continuously access said granular feed; and
a lid being hingedly coupled to said can such that said lid selectively closes said can wherein said lid is configured to inhibit animals from accessing said granular feed.

2. The assembly according to claim 1, wherein said can has a bottom end, a top end and an inner surface extending therebetween, said top end being open, said bottom end being configured to abut a bottom of the hole having said top end being aligned with the ground thereby facilitating the grazing animal to access said granular feed.

3. The assembly according to claim 2, wherein said lifting unit comprises a disk having a top surface, a bottom surface and a perimeter edge extending therebetween, said perimeter edge abutting said inside surface of said can, said granular feed being positioned on said top surface.

4. The assembly according to claim 3, further comprising a biasing member being positioned between said bottom surface of said disk and said bottom end of said can, said biasing member biasing said disk toward said top end of said can.

5. The assembly according to claim 2, wherein said lid has a first surface and an outer edge, said outer edge being hingedly coupled to said top end of said can, said first surface abutting said top end when said lid is closed.

6. A below ground feeder assembly being configured to dispense feed for a grazing animal, said assembly comprising:
a can having a height of at least 2.0 feet and a diameter of at least 1.5 feet, said can being configured to be positioned in a hole in the ground thereby facilitating said can to be concealed from hunters, said can containing a granular feed wherein said granular feed is configured to be consumed by a grazing animal, said can having a bottom end, a top end and an inner surface extending therebetween, said top end being open, said bottom end being configured to abut a bottom of the hole having said top end being aligned with the ground thereby facilitating the grazing animal to access said granular feed;
a lifting unit being movably positioned in said can, said lifting unit being biased to elevate the granular feed wherein said lifting unit is configured facilitate the grazing animal to continuously access said granular feed, said lifting unit comprising:
a disk having a top surface, a bottom surface and a perimeter edge extending therebetween, said perimeter edge abutting said inside surface of said can, said granular feed being positioned on said top surface; and
a biasing member being positioned between said bottom surface of said disk and said bottom end of said can, said biasing member biasing said disk toward said top end of said can; and
a lid being hingedly coupled to said can such that said lid selectively closes said can wherein said lid is configured to inhibit animals from accessing said granular feed, said lid having a first surface and an outer edge, said outer edge being hingedly coupled to said top end of said can, said first surface abutting said top end when said lid is closed.
